(19) United States
(12) Patent Application Publication
(10) Pub. No.: US 2016/0022084 A1
(43) Pub. Date: Jan. 28, 2016

(54) Method and apparatus for cooking mature animal portions

(71) Applicant: Carlos Godinho, Milton (CA)

(72) Inventor: Carlos Godinho, Milton (CA)

(21) Appl. No.: 14/756,030

(22) Filed: Jul. 23, 2015

(30) Foreign Application Priority Data
Jul. 23, 2014 (CA) 2857866

(51) Int. Cl. A47J 27/08; A23L 1/01; A47J 37/12; A23L 1/315

(52) U.S. Cl. CPC A47J 27/08; A23L 1/315; A23L 1/0121; A23L 1/0107; A47J 37/12

(57) ABSTRACT

A cooking method is provided for cooking mature animal portions. The cooking method includes: (A) a pressure-cooking operation including cooking the mature animal portions under pressure; and (B) a fry-cooking operation including frying the mature animal portions that were pressure cooked, and the mature animal portions being cooked by the pressure-cooking operation and the fry-cooking operation are palatable for user consumption.

### TECHNICAL FIELD

Some aspects generally relate to (and are not limited to) a cooking method and an apparatus for cooking mature animal portions; for example (and not limited thereto) the cooking of mature animal portions may include mature chicken portions such as mature chicken wings.

### SUMMARY

Based on the following, it will be appreciated that there exists a need to mitigate (at least in part) problems associated with methods for cooking chicken or mature animal portions. After much study of the known systems and methods along with experimentation, an understanding of the problem and its solution has been identified and is articulated below.

Chicken wings are served as finger food in most restaurants, and are typically known as fryer wings, the cost for which is about five Canadian dollars per kilogram to the restaurant or other equivalent facility. Fryer wings are derived (rendered) from younger chickens that range in age from about one month to about four months, but usually no more than six months of age. The younger chickens can also be called immature chicken portions or immature animal portions.

For instance, cooking chicken wings (for use in a restaurant) that are derived from mature chicken portions (which is an example of mature animal portions) proves problematic simply because the usage of mature chicken wings results in a cooked product that has a tough consistency, and is thus unpalatable for direct eating by the end user; this is especially so for the cooked mature skin, which is less than ideal from a culinary point of view. On the other hand, the cost to restaurants (and the like) for mature chicken wings is about 1.50 Canadian dollars per kilogram (by comparison to immature chicken wings).

It is known that a relatively immature animal (such as, a relatively younger chicken) is used in a process to manufacture a palatable food product (such as, a cooked chicken wing or a deep fried chicken wing) that is acceptable to the end user. This leads, naturally, to a higher demand for the relatively immature animal (resulting in a relatively higher cost for the relatively immature animal) in comparison to that of the mature animal simply because cooking mature animals tends to be unpalatable (once cooked in accordance with known methods) to the end user. Therefore, the cost of the mature animal is relatively lower than the immature animal.

It is known that the edible portions of a mature animal (such as, mature animal protein, mature chicken wings, spent fowl wings, mature meat, skin, tendons, etc.) are used in the manufacture of food products (such as, in the production of chicken broth) simply because the edible portions (such as, mature meat) are not palatable to the end user (for direct consumption, as opposed to indirect consumption). Indirect consumption (of mature animal portions) implies that the mature animal portions are cooked for the production of another food product (in order to hide the fact that the ingredients include mature animal portions in the food product), and this way the immature animal product can be rendered as palatable to the end user during the process of manufacturing the food product (for instance, chicken broth is an example of a manufactured food product that was made using mature animal portions). Therefore, the farmer faces an opportunity cost (a financial penalty) simply for allowing the immature animal to mature; the potential income of the farmer, as a result, is lower.

For instance, the mature animal (such as, the mature or spent fowl wings), once cooked in the traditional manner, produces a cooked product that has tough (unpalatable) portions (such as, skin, meat and/or tendons) that cannot be consumed (eaten) directly by the end user simply because the tough portions are not palatable to the end user. For instance, it is very difficult, if not altogether impossible, to pull (remove) the cooked tough mature meat from the bone of the mature animal (such as, the mature chicken portions) with less mechanical effort (that results in less meat wastage and/or less processing time) when compared to cooked immature meat. Even if the mature meat is removed from the bone, the mature meat (once cooked) is very tough and unappealing (unpalatable) to the end user (for direct consumption by the end user). Therefore, the tough unpalatable portions of the mature animal (once cooked in accordance with known processes and/or techniques) are used to manufacture an alternative food product that (once cooked) becomes palatable to the end user; in this way, the end user may enjoy the alternative food product simply because it is palatable to do so, and consumable portions of the mature animal are not wasted.

Examples of Unacceptable Cooking Methods

A marinade may be used in cooking the mature animal (such as, mature chicken wings). The marinade may include an additive, such as papain. Papain is an enzyme present in the leaves, roots, and fruit of the papaya plant that catalyzes the breakdown of proteins by hydrolysis (addition of a water molecule).

The mature animal (such as, aged chicken meat) is steeped in the marinade for a predetermined period of steep time; for instance, the steep time may vary from about 15 minutes to about 30 minutes. It was determined that for a relatively longer steep time (the time the mature animal was sitting in the marinade) the mature meat and/or the mature skin become tenderized (at least in part) but the tendon did not become softened in a significant way.

In a first unacceptable cooking method, raw spent fowl wings or raw mature chicken wings (as an example of raw mature animal portions) were baked (in a cooking oven) at 350 degrees Fahrenheit for about one hour to about 1.5 hours. The condition of the cooked mature wing was checked every 15 minutes. The first unacceptable cooking method produced a product that was tougher to the bite (in comparison to than a fryer wing that cooked raw immature wing portions) in the cooked mature meat, and the cooked mature tendons did not release the cooked mature meat from the bone of the mature animal. The mature cooked skin was not tough and clearly had softened (likely a result of the action of the papain in the marinade). It was noted that an increase in bake time (in the cooking oven) produced a somewhat relatively improved tenderness of the cooked mature meat (although still considered to be tough) but there was no effect on the cooked mature tendon releasing the cooked mature meat (that is, the cooked mature tendon did not release the cooked mature meat from the bone). Visually, the product (that is, the cooked mature animal) was somewhat stiff and dry, and would very likely be unpalatable to the end user.

In a second unacceptable cooking method, the mature animal portions (mature chicken wings) were fried for about one minute (in a fryer), and then the fried mature animal portion was baked for about 35 minutes at 375 degrees Fahrenheit (in the cooking oven); the result was inferior to the first unacceptable cooking method. The cooked mature animal portions were dry, tough and rubbery, and would likely be unpalatable to the end user.

In a third unacceptable cooking method, the spent fowl wings were boiled in water for about two hours. The third unacceptable cooking method produced a product (cooked mature animal portions) that was relatively more moist, but still tough to the bite and the cooked mature tendons did not easily release the cooked mature meat. Visually, the product was stiff and would likely be unpalatable to the end user.

In a fourth unacceptable cooking method, a combination of a steaming operation and then a frying operation (of the mature chicken portions) was used on a production line. The spent fowl wings (examples of the mature animal portion) were tumbled for about 20 minutes in a papain-based marinade. The raw spent fowl wings were boiled in water (the steaming time was adjusted from about nine minutes to about thirteen minutes). Once steamed, the partly cooked spent fowl wings were fried (the frying time was adjusted from about 90 seconds to about 60 seconds at about 375 degrees Fahrenheit). The fourth unacceptable cooking method produced a product (cooked mature animal portions) that had a better bite, and had improved tender cooked mature skin and cooked mature meat, but the cooked mature tendon was tough and it was difficult to release the cooked mature meat from the bone as a result of the cooked mature tendon being tough. Visually, the product (cooked mature animal portions) was still stiff and would likely be unpalatable to the end user.

In a fifth unacceptable cooking method, the spent fowl wing (an example of the mature animal portions) was fried from about five minutes and up to about ten minutes; then, the partly cooked spent fowl wing was steamed for about one minute; the result was inferior to the fourth unacceptable cooking method (and this would be unpalatable to the end user).

In view of the above, what is needed to solve the problem (in general terms) is a cooking method (cooking process) that, for instance, cooks the mature meat portions (such as, mature chicken portions, or more specifically mature chicken wings) into a state or condition that is not only edible by the end user but is also appealing and palatable to the end user (thereby, the cooked mature portion of the animal may be eaten directly by the end user without having to use the mature portions in an alternative food product).

Accordingly, there is provided a cooking method for cooking mature animal portions (such as, mature chicken portions and, more specifically, mature chicken wings) that yields a significant financial advantage. The cooking method renders the mature animal portions (such as, the mature chicken wings) with improved tenderness (of the meat). For instance, the cooking method provides an economically viable option for fryer wings.

Several examples are described for cooking mature meat (specifically, chicken wings) that address the toughness (rigidity) of the mature meat, the mature skin, and/or the mature tendons of the mature chicken.

The example of the cooking processes described below provides a combination of different operations that are configured to break down the toughness of the mature animal (such as, spent fowl wing), and thereby produce a palatable food product (such as, a cooked wing). In this way, even if the farmer allows the animal to mature, there is now a demand for his mature animals since the cooking method allows the mature animals to be palatable to the end user, and thereby may compete against cooked immature animals.

In order to mitigate, at least in part, the problem(s) identified with existing cooking methods for cooking mature chicken wings, there is provided (in accordance with an aspect) a cooking method for cooking mature animal portions; the cooking method includes a pressure-cooking operation including cooking the mature animal portions under pressure, and a fry-cooking operation including frying the mature animal portions that were pressure cooked, and the mature animal portions being cooked by the pressure-cooking operation and the fry-cooking operation are palatable for user consumption.

In order to mitigate, at least in part, the problem(s) identified above, in accordance with an aspect, there is provided an apparatus for cooking mature animal portions; the apparatus includes: a pressure-cooking section being configured to: receive the mature animal portions, and cook the mature animal portions that were received under pressure with boiling water; and a fryer-cooking section being positioned relative to the pressure-cooking section, and the fryer-cooking section being configured to: receive the mature animal portions that were pressure cooked, and fry the mature animal portions that were pressure cooked with boiling oil.

In order to mitigate, at least in part, the problem(s) identified above, in accordance with an aspect, there is provided other aspects as identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIGS. 1A to 1F depict examples of operations used in a cooking method for cooking mature animal portions;

FIG. 2 depicts an example of a marinating operation used in a cooking method for cooking mature animal portions;

FIGS. 3A to 3C depict examples of a pressure-cooking operation used in a cooking method for cooking mature animal portions;

FIG. 4 depicts an example of a fry-cooking operation used in a cooking method for cooking mature animal portions;

FIG. 5 depicts an example of operations used in a cooking method for cooking mature animal portions;

FIGS. 6A and 6B depict examples of operations used in a cooking method for cooking mature animal portions;

FIGS. 6C and 6D depict examples of an apparatus for cooking mature animal portions; and

FIG. 7 depicts examples of mature animals that may provide mature animal portions to be used in a cooking method for cooking the mature animal portions.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating an understanding of the various presently disclosed embodiments. In addition, common, but well-understood, elements that are useful or necessary in commercially feasible embodiments are often not depicted in order to facilitate a less obstructed view of the various embodiments of the present disclosure.

### LISTING OF REFERENCE NUMERALS USED IN THE DRAWINGS

100 mature chicken
102 carcass
104 mature wing portion
106 mature neck portion
108 mature back portion
110 mature thigh portion
112 mature leg portion
114 mature foot portion
116 mature breast portion
118 mature wing portion
120 knife
122 chicken-processing apparatus
200 marinating apparatus
202 water
204 marinade
206 mature wing portion
300 pressure cooker
302 lid assembly
308 mature wing
400 fryer
402 cooked mature wing portion
404 bag
406 packing container
408 freezer apparatus
410 refrigerated shipping truck
502 cooking appliance
504 restaurant
600 cooking method
602 pressure-cooking operation
604 fry-cooking operation
606 marinating operation
702 chicken
704 turkey
706 goose
708 duck
710 pig
712 cow
714 rabbit
716 goat
718 sheep
720 deer
722 moose
900 apparatus
902 pressure-cooking section
904 fryer-cooking section
906 marinating section
908 frame assembly

### DETAILED DESCRIPTION OF THE EXEMPLARY EMBODIMENTS

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of the description herein, the terms “upper,” “lower,” “left,” “rear,” “right,” “front,” “vertical,” “horizontal,” and derivatives thereof shall relate to the examples as oriented in the drawings. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments (examples), aspects and/or concepts defined in the appended claims. Hence, specific dimensions and other physical characteristics relating to the embodiments disclosed herein are not to be considered as limiting, unless the claims expressly state otherwise. It is understood that “at least one” is equivalent to “a”. The aspects (examples, alterations, modifications, options, variations, embodiments and any equivalent thereof) are described with reference to the drawings. It should be understood that the invention is limited to the subject matter provided by the claims, and that the invention is not limited to the particular aspects depicted and described.

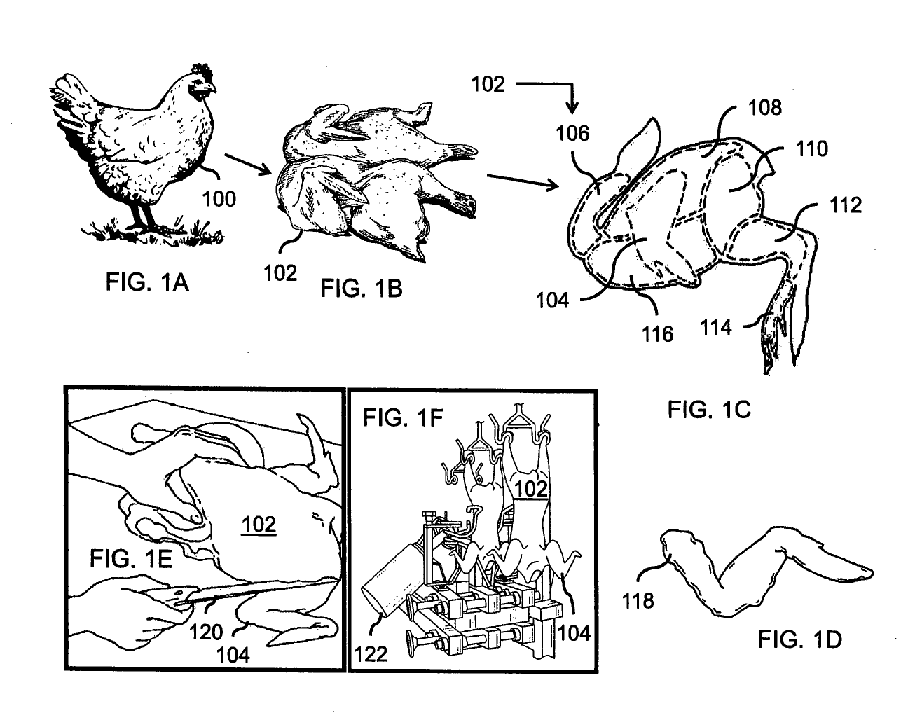

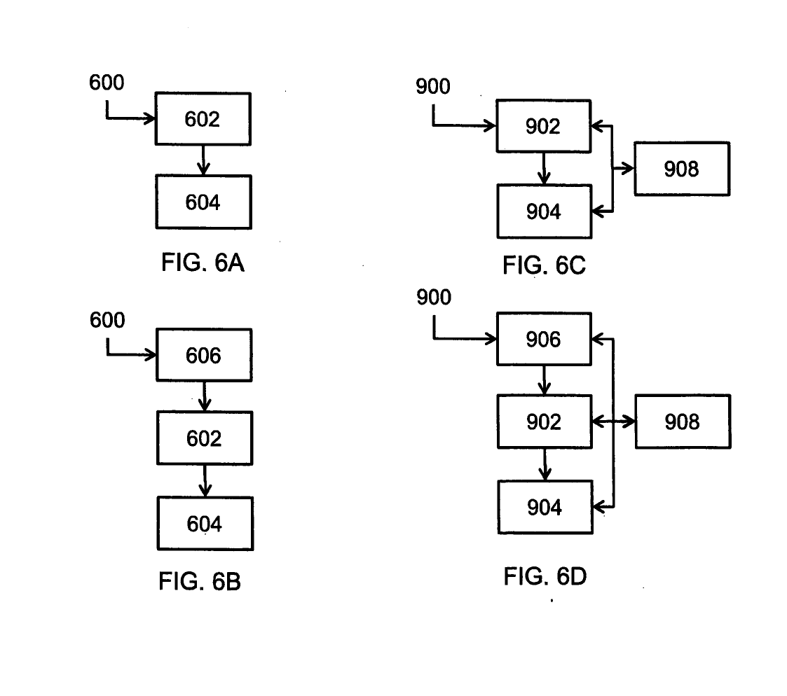

FIGS. 1A to 1F depict examples of operations used in a cooking method 600 for cooking mature animal portions. The examples of the cooking method 600 are depicted in FIGS. 6A and 6B.

FIG. 1A depicts a side view of an example of a mature chicken 100, which is an example of a mature animal from which mature animal portions are to be rendered for use in the cooking method 600 of FIGS. 6A and 6B.

FIG. 1B depicts a perspective view of an example of a carcass 102 of the mature chicken 100 of FIG. 1A.

FIG. 1C depicts a side view of the carcass 102 of FIG. 1B which is to be rendered into mature animal portions. The carcass 102 includes a mature wing portion 104, a mature neck portion 106, a mature back portion 108, a mature thigh portion 110, a mature leg portion 112, a mature foot portion 114, and a mature breast portion 116.

FIG. 1D depicts a side view of an example of a mature wing portion 118 that was rendered from the mature chicken 100 of FIG. 1A. The mature wing portion 118 is an example of a mature animal portion.

FIG. 1E depicts a rendering operation including rendering the mature wing portion 104 from the carcass 102 of FIG. 1B. In accordance with FIG. 1E, the mature wing portion 104 is cut from the carcass 102 by manually using a knife 120 (or anything equivalent).

FIG. 1F depicts a rendering operation including rendering the mature wing portion 104 from the carcass 102 of FIG. 1B. In accordance with FIG. 1F, the mature wing portion 104 is cut from the carcass 102 by using a chicken-processing apparatus 122 (or anything equivalent).

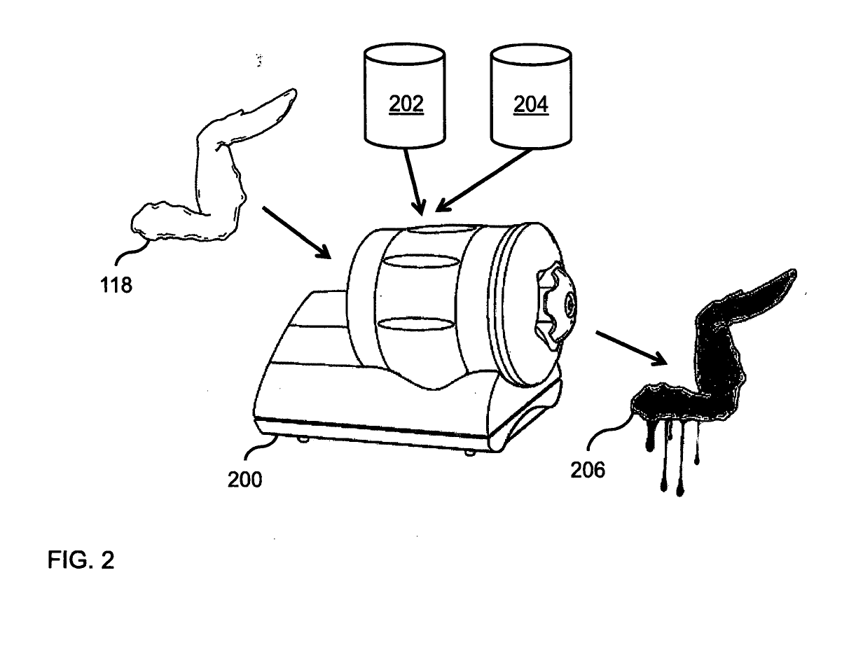

FIG. 2 depicts an example of a marinating operation 606 used in a cooking method 600 for cooking mature animal portions.

An example of the marinating operation 606 is depicted in FIG. 6B. The mature wing portion 118 of FIG. 1D is placed (inserted) into a marinating apparatus 200, which may simply be a bucket (for example) or a marinating food tumbler apparatus. Another example of the marinating apparatus 200 is the marinating section 906 depicted in FIG. 6D. In addition to inserting the mature wing portion 118 into the marinating apparatus 200, water 202 is inserted into the marinating apparatus 200 and a marinade 204 is inserted into the marinating apparatus 200. For the case where the marinating apparatus 200 includes a tumbler apparatus, the marinating apparatus 200 is energized for a predetermined period of time suitable for marinating the mature wing portion 118 (according to desired taste). Once the marinating operation 606 is completed, a marinated instance of the mature wing portion 206 is removed from the marinating apparatus 200, and is used for other operations associated with the cooking method 600 depicted in FIGS. 6A and/or 6B.

Prior to cooking the mature animal portions, the cooking method includes a marinating operation. It will be appreciated that the marinating operation is optional. The marinating operation includes soaking (steeping) the raw mature animal portions (such as, aged chicken meat, mature chicken wings) in a marinade for a period of marinade steep time (which may be predetermined or not predetermined). The marinade steep time may vary according to the type of mature animal portions that are to be cooked. For instance, the marinade may include a combination of tenderizing ingredients, such as papain, ginger, salt, soy sauce, etc. For instance, the marinade may include the following combination of tenderizing ingredients (for cooking about two pounds of spent fowl wings): about two teaspoons of soya sauce, about two teaspoons of salt, about a two-inch piece of ginger cut in slices, three green onions, four cloves of garlic, and about three inches of fresh fennel stalk and bulb (alternatively, star anise may be used if desired as an alternative to fennel).

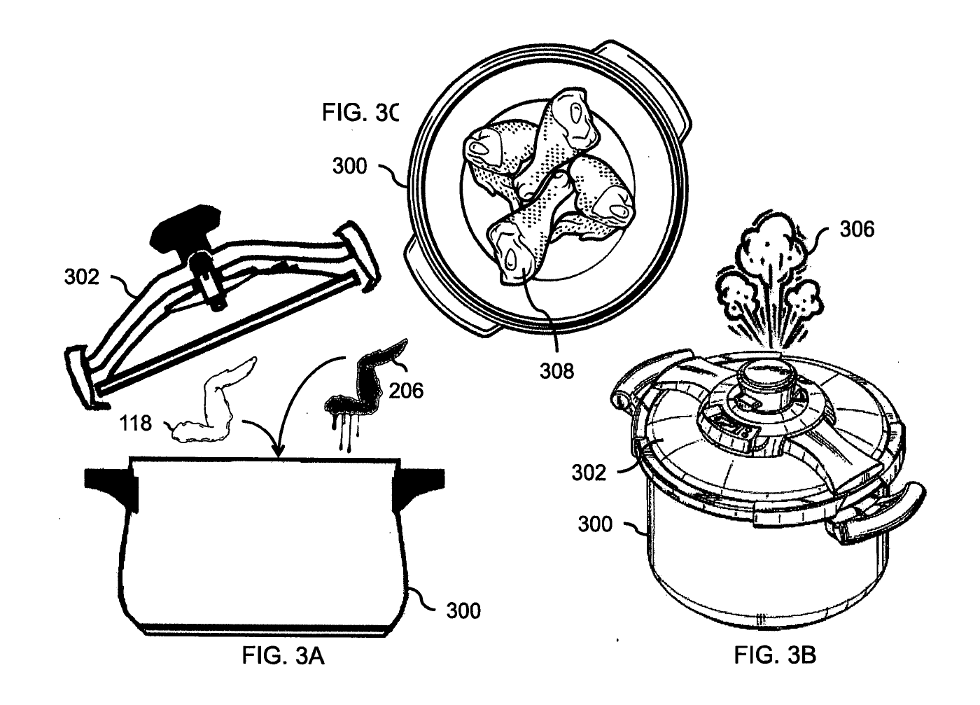

FIGS. 3A to 3C depict examples of a pressure-cooking operation 602 used in a cooking method 600 for cooking mature animal portions.

Examples of the pressure-cooking operation 602 are depicted in FIGS. 6A and/or 6B. The mature wing portion 118 of FIG. 1D and/or the mature wing portion 206 of FIG. 2 is inserted into the interior of a pressure cooker 300. An example of the pressure cooker is depicted in FIGS. 6C and/or 6D.

FIG. 3A depicts the pressure cooker 300 in an open state in which a lid assembly 302 is removed from the opening of the pressure cooker 300 that leads into an interior of the pressure cooker 300. The mature wing portion 118 and/or the mature wing portion 206 are received in the pressure cooker 300.

FIG. 3B depicts the pressure cooker 300 in an operating state in which the lid assembly 302 has been closed and sealed. The pressure cooker 300 is operated in such a way that the mature wing portion 118 and/or the mature wing portion 206 become cooked under pressure.

FIG. 3C depicts the pressure cooker 300 in which the lid assembly 302 has been removed from the pressure cooker 300 in order to provide access to the interior of the pressure cooker; in this manner, the cooked instances of the mature wing 308 that were cooked by the pressure-cooking operation 602 may be removed from the pressure cooker 300. It will be appreciated that the mature animal portions cooked by the pressure cooker 300 may include any portion that was rendered from the mature chicken 100 of FIG. 1A and/or from the carcass 102 of FIG. 1B.

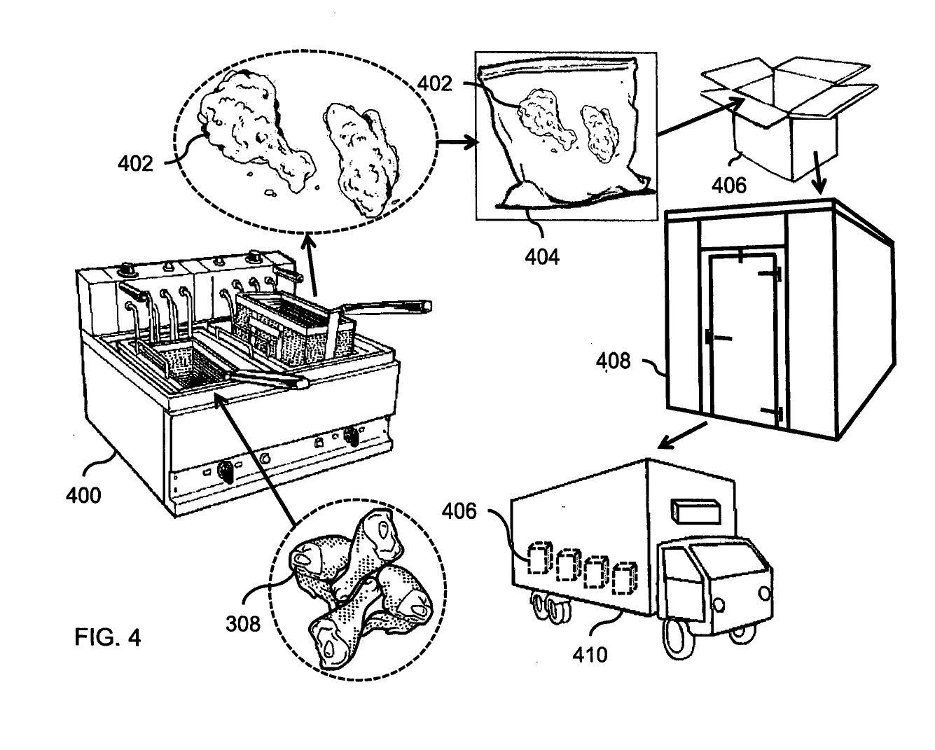

FIG. 4 depicts an example of a fry-cooking operation 604 used in a cooking method 600 for cooking mature animal portions.

An example of the fry-cooking operation 604 is depicted in FIGS. 6A and 6B. A fryer 400 (also called a deep fryer) is configured to execute the fry-cooking operation 604. Another example of equipment configured to execute the fry-cooking operation 604 is depicted as the fryer-cooking section 904 in FIGS. 6C and 6D. The mature wing 308 cooked by the pressure cooker 300 of FIG. 3 is inserted into the fryer 400 (specifically, inserted into a basket which is then inserted or lowered into the boiling oil contained by the fryer 400). Once the mature wing 308 has been cooked to desired effect (taste) by the fryer 400, the result is the cooked mature wing portion 402. The cooked mature wing portion 402 is inserted into a bag 404 (such as a freezer bag). The bag 404 is inserted into a packing container 406. The packing container 406 is placed in a freezer apparatus 408. Eventually, the instances of the packing container 406 are removed from the freezer apparatus 408 and then placed in a refrigerated shipping truck 410, and shipped to restaurants and/or shopping stores (and anything equivalent thereof).

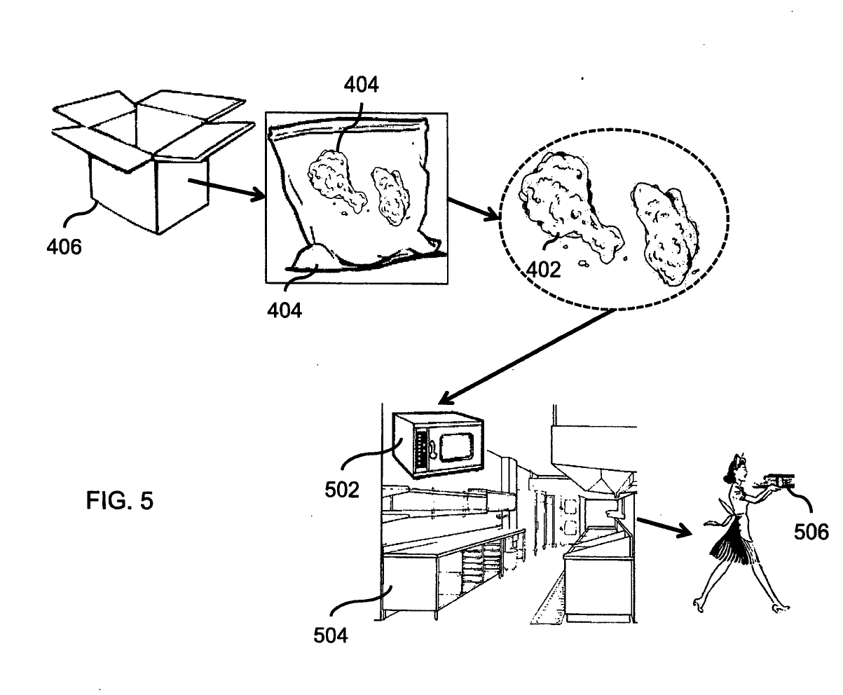

FIG. 5 depicts an example of operations used in a cooking method for cooking mature animal portions.

The packing container 406 is received by the operators of a restaurant 504 (a cooking establishment). The bag 404 is removed from the packing container 406. The cooked mature wing portion 402 is removed from the bag 404. The cooked mature wing portion 402 is further cooked (heated, etc.) in a cooking appliance 502 (such as a microwave oven, etc.) located in the restaurant 504. Once the cooked mature wing portion 402 is cooked to the requirements, the cooked instance of the cooked mature wing portion 402 is served to end users (for direct eating).

FIGS. 6A and 6B depict examples of operations used in a cooking method 600 for cooking mature animal portions.

In accordance with a general example, the cooking method 600 is for cooking mature animal portions. The cooking method 600 includes (and is not limited to) a combination of a pressure-cooking operation 602 and a fry-cooking operation 604. The pressure-cooking operation 602 includes cooking the mature animal portions under pressure. The fry-cooking operation 604 includes frying the mature animal portions that were pressure cooked. The mature animal portions that were cooked by the pressure-cooking operation 602 and the fry-cooking operation 604 are palatable for user consumption.

In accordance with a specific option of the cooking method 600, the cooking method 600 further includes a marinating operation 606. The marinating operation 606 includes marinating the mature animal portions prior to pressure cooking the mature animal portions.

In accordance with another specific option of the cooking method 600, the cooking method 600 is adapted such that the pressure-cooking operation 602 includes cooking the mature animal portions under pressure in a pressure-cooking section 902 with boiling water. Examples of the pressure-cooking section 902 are depicted in FIGS. 6C and 6D.

In accordance with another specific option of the cooking method 600, the cooking method 600 is adapted such that the fry-cooking operation 604 includes frying the mature animal portions that were pressure cooked in a fryer-cooking section 904 with boiling oil. Examples of the fryer-cooking section 904 are depicted in FIGS. 6C and 6D.

In accordance with another specific option of the cooking method 600, the cooking method 600 is adapted such that the pressure-cooking operation 602 includes cooking the mature animal portions at a predetermined pressure range for a predetermined amount of time.

In accordance with another specific option of the cooking method 600, the cooking method 600 is adapted such that the fry-cooking operation 604 includes frying the mature animal portions that were pressure cooked at a predetermined temperature range for a predetermined amount of time.

In accordance with another specific option of the cooking method 600, the cooking method 600 is adapted such that the pressure-cooking operation 602 includes cooking the mature animal portions under pressure at about 15 pounds per square inch for between about 18 minutes and about 20 minutes.

In accordance with another specific option of the cooking method 600, the cooking method 600 is adapted such that the fry-cooking operation 604 includes frying the mature animal portions that were pressure cooked in boiling oil between at about 375 degrees Fahrenheit and at about 395 degrees Fahrenheit for about 60 seconds to about 70 seconds.

In accordance with another specific option of the cooking method 600, the cooking method 600 is adapted such that the mature animal portions include (for example) mature chicken portions.

In accordance with another specific option of the cooking method 600, the cooking method 600 is adapted such that the mature animal portions include (for example) mature chicken wings.

In accordance with a specific example, the cooking method 600 is for cooking mature chicken wings, and the cooking method 600 includes (and is not limited to): an operation (A) including obtaining raw mature chicken wings; an operation (B) including marinating (seasoning and/or spicing) the mature chicken wings that were obtained (or rendered) in a marinating apparatus 200 (depicted in FIG. 2) prior to pressure cooking the mature chicken wings; it will be appreciated that operation (B) is optional if so desired; an operation (C) including bringing water in a pressure cooker 300 (depicted in FIG. 3) to a boil; an operation (D) including adding the mature chicken wings to the boiling water in the pressure cooker 300; an operation (E) including bringing the water to boil again in the pressure cooker 300 with wings in the water; an operation (F) including cooking the mature wings under pressure (such as at 15 pounds per square inch) for a predetermined time (such as between about 18 minutes and about 20 minutes; an operation (G) including removing the pressure-cooked mature chicken wings from the pressure cooker 300, and allowing water to drain from the mature chicken wings (that were pressure cooked); an operation (H) including adding the pressure-cooked wings to boiling cooking oil in a fryer 400 (depicted in FIG. 4); an operation (I) including deep frying the pressure-cooked wings in boiling oil at a predetermined temperature range (such as at about 375 degrees Fahrenheit to at about 395 degrees Fahrenheit) for a predetermined period of time (such as about 60 seconds to about 70 seconds); an operation (J) including air drying the deep fried wings, and allowing excess oil to drip from the deep fried wings (such as, for at least 10 seconds, etc.); and an operation (K) including freezing the cooked wings for packaging for commercial sale preferably using an IQF (individual quick freezing) process (if so desired). It will be appreciated that the above operations are not all necessary (some operations may be removed if desired) and the order may be adjusted if so desired.

In accordance with a specific option, the cooking method 600 for cooking spent fowl wings. The cooking method 600 includes cooking the spent fowl wings (mature chicken wings) in a pressure cooker 300 (depicted in FIG. 3) for about 25 minutes (a predetermined time) at about 15 pounds per square inch (a predetermined pressure). The cooking method 600 also includes cooking the spent fowl wings, which had been cooked in the pressure cooker 300, in a fryer 400 (depicted in FIG. 4) for about three minutes (a predetermined time) without measured temperature for frying. The resulting product had improved tenderness, both in the cooked mature skin and the cooked mature meat. The cooked mature tendons were softened and thus allowed the release of the cooked mature meat well from the bone (relatively easier). The outside was crispy and the bite and texture was comparable to a regular cooked fryer wing, though a little dry. The look of the chicken wing was a little disheveled with the tendons separated completely from the bone.

The cooking method includes a pressure-cooking operation. The pressure-cooking operation includes placing the spent fowl wings (which are examples of the raw mature animal portions) in a pressure cooker, and cooking the spent fowl wings (received in the pressure cooker) for about 25 minutes (a predetermined time) at about 15 pounds per square inch (a predetermined pressure, which is the internal pressure of the pressure cooker).

The cooking method further includes a fry-cooking operation. The fry-cooking operation includes placing the spent fowl wings that were cooked in the pressure-cooking operation in a fryer, and cooking the spent fowl wings (received in the fryer) for about three minutes (a predetermined time; the fryer may be placed on a stovetop if desired) without a measured temperature (a predetermined cooking temperature) for frying the spent fowl wings. It was noted that the resulting product (the cooked spent fowl wings) were tender (both in the cooked mature skin and the cooked mature meat). In addition, the cooked mature tendons were softened to the point where the cooked mature tendon released the cooked spent fowl wings from the bone (with little mechanical separation force applied in such a way as to separate the cooked mature meat from the bone). The cooked mature tendons of the cooked spent fowl wings separated completely from the bone. The outside surface of the cooked spent fowl wings was crispy, and the bite and texture was palatable.

First Option for Cooking Method

The following describes a first option for the cooking method 600. The cooking method 600 includes an obtaining operation. The obtaining operation includes obtaining (rendering) an amount of the raw spent fowl wings; for instance, the weight of the obtained amount of the raw spent fowl wings was 5028 grams.

The cooking method 600 further includes a boiling operation. The boiling operation includes boiling water in a pressure cooker 300 (depicted in FIG. 3); the pressure cooker 300 may have, for instance, a twenty-liter capacity.

In accordance with an option, the cooking operation includes a marinating operation. The marinating operation includes adding marinade ingredients to the water used in the boiling operation. The marinade ingredients may be added before boiling the water in the pressure cooker 300.

The cooking method 600 further includes a pressure-cooking operation. The pressure-cooking operation includes closing the lid of the pressure cooker 300 (depicted in FIG. 3). The pressure-cooking operation also includes increasing (bringing) the internal pressure of the pressure cooker 300 to an internal pressure (for example, at about 15 pounds per square inch, which is a predetermined internal pressure).

The pressure-cooking operation also includes pressure cooking the raw spent fowl wings in the pressure cooker 300 (depicted in FIG. 3) for a predetermined amount of time (for instance, about 18 minutes) once the internal pressure of the pressure cooker 300 has reached a predetermined pressure level (such as, about 15 pounds per square inch).

The pressure-cooking operation also includes allowing the spent fowl wings in the pressure cooker 300 (depicted in FIG. 3) to cool down before removing the spent fowl wings from the pressure cooker 300.

The pressure-cooking operation also includes removing the spent fowl wings from the pressure cooker 300.

The cooking method 600 also includes allowing the spent fowl wings to dry (for instance, drip dry).

The cooking method 600 also includes placing the spent fowl wings that were cooked in the pressure cooker 300 into a fryer 400 (depicted in FIG. 4).

The cooking method 600 also includes a frying operation. The frying operation includes frying the spent fowl wings that were received into the fryer 400 for a predetermined time period (such as, about one minute and 45 seconds) at a predetermined temperature (such as, about 190 degrees Celsius or 375 degrees Fahrenheit).

The cooking method 600 also includes removing the spent fowl wings from the fryer 400. It was noted that the weight of the cooked spent fowl wings that were removing from the fryer 400 was about 2602 grams, and the yield (without the marinade) was about 51%.

The following five examples demonstrate an approach for determining cooking times for the pressure cooker 300 (depicted in FIG. 3) and the fryer 400 (depicted in FIG. 4). It will be appreciated that the marinating time for the marinating apparatus 200 (depicted in FIG. 2) will depend on taste (a subjective variable).

### First Example

In accordance with the first example of the cooking method 600, the cooking method 600 includes an obtaining operation; the obtaining operation includes obtaining an amount of the raw spent fowl wings (a start weight was determined to be about 1506 grams).

The cooking method 600 further includes a placing operation; the placing operation includes placing the marinade ingredients in water.

The cooking method 600 further includes a boiling operation; the boiling operation includes boiling the water and the marinade in a pressure cooker 300; alternatively, prior to placing the water and marinade into the pressure cooker 300, the combination of the water and marinade are boiled outside of the pressure cooker 300, and then, once boiled, the combination is placed into the pressure cooker 300.

The cooking method 600 further includes an adding operation; the adding operation includes adding the raw spent fowl wings into the pressure cooker 300.

The cooking method 600 further includes a covering operation; the covering operation includes covering (and sealing) the pressure cooker in such a way that the internal pressure of the pressure cooker 300 may be increased.

The cooking method 600 further includes a pressure cooking operation; the pressure cooking operation includes cooking the raw spent fowl wings in the pressure cooker for about 10 minutes once the internal pressure of the pressure cooker 300 is about 15 pounds per square inch.

The cooking method 600 further includes a cooling operation; the cooling operation includes cooling down the spent fowl wings cooked by the pressure cooker; for instance, the spent fowl wings may be relatively quickly cooled down with cold water. It was noted that the spent fowl cooked by the pressure cooker were tough and hard to the touch, and visually stiff. Once this was determined, the cooking time for the pressure cooker was determined to not be long enough.

The cooking method 600 further includes a further pressure cooking operation, including closing the lid to the pressure cooker, and pressure cooking the spent fowl wings placed in the pressure cooker for about an additional five minutes (for a total pressure cooking time under pressure for about fifteen minutes).

The cooking method 600 further includes a further cooling operation, including cooling down the spent fowl wings (preferably using a relatively faster cool down process) using cold water (rinsing the spent fowl wings with cold water). It was noted that the spent fowl wings were softer but still stiff and hard to the touch, and the cooked mature skin was beginning to breakdown.

The cooking method 600 further includes a further pressure cooking operation, including closing the lid to the pressure cooker 300, and pressure cooking the spent fowl wings that were placed in the pressure cooker 300 for about an additional five minutes (for a total pressure cooking time under pressure for about twenty minutes). It will be appreciated that some experimentation and testing may be required including reiteration operations in order to identify optimum cooking times, pressure settings, temperature settings depending on the type of mature animal portions.

The cooking method 600 further includes a further cooling operation, including cooling down the spent fowl wings (preferably using a relatively faster cool down process) using cold water (rinsing the spent fowl wings with cold water). It was noted that the cooked mature skin was soft and the cooked matured meat was softer but still firm and tough at the cooked mature tendons; the cooked mature meat was not easily released from the bone.

The cooking method 600 further includes a frying operation, including frying the spent fowl wings (that were pressure cooked) for about two minutes at about 190 degrees Celsius or about 375 degrees Fahrenheit. It was noted that the spent fowl wings that were fried were edible but tough to chew.

The cooking method 600 further includes a further pressure cooking operation, including closing the lid to the pressure cooker 300, and pressure cooking the spent fowl wings placed in the pressure cooker 300 for about an additional five minutes (for a total pressure cooking time under pressure for about twenty five minutes).

The cooking method 600 further includes a further cooling operation, including cooling down the spent fowl wings (preferably using a relatively faster cool down process) using cold water (rinsing the spent fowl wings with cold water). It was noted that the cooked mature skin and the cooked mature meat were soft, and the cooked mature meat was easily released from the bone, and the cooked mature tendons were soft. It was noted that the post pressure cooked weight was about 1006 grams and the yield was about 66%.

The cooking method 600 further includes a further frying operation, including frying the spent fowl wings (that were pressure cooked for 25 minutes) for about two minutes at about 190 degrees Celsius or about 375 degrees Fahrenheit. It was noted that the spent fowl wings that were fried were crispy and though they had a good bite, the spent fowl wings could use a bit more moisture. It was determined that the fry time could be reduced in order to obtain the required amount of moisture in the spent fowl wings (once fried). It was noted that the end weight was about 822 grams, and the yield from frying was about 81%, and that the total yield from start was about 54%.

### Second Example

The following describes a second example for the cooking method 600. The cooking method 600 includes an obtaining operation. The obtaining operation includes obtaining an amount of the raw spent fowl wings; for instance, the weight of the obtained amount of the raw spent fowl wings was 538 grams.

The cooking method 600 further includes a boiling operation. The boiling operation includes boiling water in a pressure cooker; the pressure cooker may have, for instance, a twenty-liter capacity.

In accordance with an option, the cooking method 600 includes a marinating operation. The marinating operation includes adding marinade ingredients to the water used in the boiling operation. The marinade ingredients may be added before boiling the water in the pressure cooker 300.

The cooking method 600 further includes a pressure-cooking operation. The pressure-cooking operation includes closing the lid of the pressure cooker 300. The pressure-cooking operation also includes increasing (bringing) the internal pressure of the pressure cooker 300 to a predetermined internal pressure level (for example, at about 15 pounds per square inch).

The pressure-cooking operation also includes pressure cooking the raw spent fowl wings in the pressure cooker for a predetermined amount of time (for instance, about 30 minutes) once the internal pressure of the pressure cooker has reached about 15 pounds per square inch.

The pressure-cooking operation also includes removing the spent fowl wings from the pressure cooker.

The pressure-cooking operation also includes allowing the spent fowl wings in the pressure cooker to cool down before removing the spent fowl wings from the pressure cooker (preferably with a relatively faster cool down by running cold water over the pressure-cooked spent fowl wings).

The pressure-cooking operation also includes allowing the spent fowl wings to dry (for instance, drip dry). It was noted that the spent fowl wings had improved tenderness; the mature skin, mature meat and the mature tendons were soft; from a visual perspective, the spent fowl wings appeared to be intact. It was noted that the post pressure cooked weight was about 374 grams and the yield was about 69%.

The cooking method 600 also includes placing the spent fowl wings that were cooked in the pressure cooker into a fryer.

The cooking method. 600 also includes a frying operation. The frying operation includes frying the spent fowl wings that were received into the fryer for about one minute and 45 seconds at about 190 degrees Celsius or 375 degrees Fahrenheit.

The cooking method 600 also includes removing the spent fowl wings from the fryer. It was noted that the spent fowl wings that were fried were crispy and had a good bite; the moisture of the spent fowl wings was acceptable but could be better. It was determined to reduce the frying time. It was noted that the end weight was about 300 grams and the yield from frying was about 80%, and the total yield from start was about 55%.

### Third Example

The cooking method 600 includes an obtaining operation. The obtaining operation includes obtaining an amount of the raw spent fowl wings; for instance, the weight of the obtained amount of the raw spent fowl wings was 540 grams.

The cooking method 600 further includes a boiling operation. The boiling operation includes boiling water in a pressure cooker; the pressure cooker may have, for instance, a twenty-liter capacity.

In accordance with an option, the cooking operation includes a marinade-adding operation. The marinade-adding operation includes adding marinade ingredients to the water used in the boiling operation. The marinade ingredients may be added before boiling the water in the pressure cooker. The water and marinade may be boiled before being placed into the pressure cooker.

An adding operation includes adding the spent fowl wings to the interior of the pressure cooker 300.

The cooking method 600 further includes a pressure-cooking operation. The pressure-cooking operation includes closing the lid of the pressure cooker. The pressure-cooking operation also includes increasing (bringing) the internal pressure of the pressure cooker 300 to an internal pressure (for example, at about 15 pounds per square inch).

The pressure-cooking operation also includes pressure cooking the raw spent fowl wings in the pressure cooker 300 for a predetermined amount of time (for instance, about 35 minutes) once the internal pressure of the pressure cooker 300 has reached about 15 pounds per square inch.

The pressure-cooking operation also includes removing the spent fowl wings from the pressure cooker 300.

The pressure-cooking operation also includes allowing the spent fowl wings in the pressure cooker 300 to cool down before removing the spent fowl wings from the pressure cooker 300 (preferably with a relatively faster cool down by running cold water over the pressure cooked spent fowl wings.

The pressure-cooking operation also includes allowing the spent fowl wings to dry (for instance, drip dry). It was noted that the spent fowl wings were tender, and the mature skin, mature meat and mature tendons were softer. Visually, the cooked spent fowl wings were intact but some tearing and falling apart of the cooked mature skin was noted. The drumettes meat (the thick section of a chicken wing that resembles a drumstick) completely released from the bone at the smaller end. It was noted that the post pressure cooked weight was about 380 grams and the yield was about 70%.

The cooking method 600 also includes placing the spent fowl wings that were cooked in the pressure cooker into a fryer.

The cooking method 600 also includes a frying operation. The frying operation includes frying the spent fowl wings that were received into the fryer for about one minute and 45 seconds at about 190 degrees Celsius or 375 degrees Fahrenheit.

The cooking method 600 also includes removing the spent fowl wings from the fryer. It was noted that the spent fowl wings that were cooked by the fryer were crispy and had a good bite; the moisture was acceptable but could be improved; therefore, the fry time was reduced. It was noted that the end weight was about 300 grams and the yield from frying was about 78%, and the total yield from start was about 55%.

### Fourth Example

For the fourth example, a marinade was added and an operation for blanching was added to the cooking method 600.

The start weight of the raw spent fowl wings was about 5000 grams. The start weight of the marinade was about 220 grams. The weight of the water was about 560 grams. The total weight was about 5780 grams.

The cooking method 600 includes inserting the raw spent fowl wings, the water and the marinade into a marinating apparatus 200 depicted in FIG. 2 (which is an example of a marinade container).

The cooking method 600 includes tumbling the raw spent fowl wings, the water and the marinade placed into the tumbler for a duration of time (for instance, about 55 minutes at 25 pounds per square inch). It was noted that the total wing weight post marinade was 5568 grams, and the yield pick-up was about 11.3%.

The cooking method 600 further includes removing the water and marinade mixture from the marinating apparatus 200 (depicted in FIG. 2) and then placing the water and marinade combination into the interior of a pressure cooker 300 (depicted in FIG. 3). Alternatively, another batch of the marinade may be made and introduced to the pressure cooker (leaving the water and marinade combination in the tumbler for use with another batch of raw spent fowl wings).

The cooking method 600 further includes bringing the marinade and water that was placed into the pressure cooker to a boil.

The cooking method 600 further includes blanching the spent fowl wings for a predetermined period of time (such as for about one minute) in boiling water in a cooking pot (not in the pressure cooker); this operation was performed to see if bringing the temperature of the spent fowl wings up would shorten the time to achieve pressure in the pressure cooker and increase the yield.

The cooking method 600 further includes adding the spent fowl wings that were boiled in the cooking pot into the pressure cooker.

The cooking method 600 includes covering and sealing the pressure cooker.

The method includes increasing the internal pressure to 15 PSI; it was noted that the total time taken to reach 15 pounds per square inch was about 38 minutes.

The pressure-cooking operation also includes pressure cooking the raw spent fowl wings in the pressure cooker for a predetermined amount of time (for instance, about 25 minutes) before the internal pressure of the pressure cooker has reached about 15 pounds per square inch.

The pressure-cooking operation also includes allowing the spent fowl wings in the pressure cooker to cool down before removing the spent fowl wings from the pressure cooker (preferably with a relatively faster cool down by running cold water over the pressure cooked spent fowl wings). It was noted that the spent fowl wings had improved tenderness, and the mature skin, mature meat and mature tendons were soft. However, some tearing of the cooked mature skin was noticed and the skin appeared fragile. It was noted that the post pressure cooked weight was about 3634 grams and the yield was about 73%.

The cooking method 600 includes frying the spent fowl wings in a deep fryer for one minute and 30 seconds at about 190 degrees Celsius or 375 degrees Fahrenheit. It was noted that the spent fowl wings that were removed from the fryer were slightly golden in color and had a good bite; the moisture was retained, and the spent fowl wings tasted juicy. It was noted that the end weight was about 3040 grams, and the yield from frying was about 83%, and the total yield from start was about 61%.

### Fifth Example

For the fifth example, a marinating operation was added but the blanching operation was not used.

The method includes obtaining an amount of the raw spent fowl wings (for example, 5278 grams), an amount of the marinade (for example, 233 grams), and an amount of water (for example, 560 grams). The total weight is about 6070 grams.

The method includes adding the raw spent fowl wings to the marinating apparatus 200.

The method includes operating the marinating apparatus 200 for about 55 minutes at about a pressure of about 30 pounds per square inch. It was noted that the total weight of the spent fowl wings post marinade was about 5972 grams, and the yield pick-up was about 13.1%.

The method includes placing the marinade and water from the marinating apparatus 200 into a pressure cooker 300, and then brining the marinade and water to a boil.

The method includes adding the spent fowl wings into the pressure cooker 300 and covering the pressure cooker 300.

It was noted that the total time, before 15 pounds per square inch was achieved in the pressure cooker was about 27 minutes; therefore, blanching appears to have no effect in shortening the time under pressure in the pressure cooker 300.

The pressure-cooking operation also includes pressure cooking the raw spent fowl wings in the pressure cooker for a predetermined amount of time (for instance, about 20 minutes) before the internal pressure of the pressure cooker 300 has reached about 15 pounds per square inch.

The pressure-cooking operation also includes allowing the spent fowl wings in the pressure cooker 300 to cool down before removing the spent fowl wings from the pressure cooker 300 (preferably with a relatively faster cool down by running cold water over the pressure cooked spent fowl wings). It was noted that the spent fowl wings were tender, and the cooked mature skin, the cooked mature meat and the cooked mature tendons were soft. However, some tearing of the cooked mature skin was noticed and the skin appeared to be fragile. It was noted that the post pressure cooked weight was about 3880 grams, and the yield was about 73.5%.

The amount of the spent fowl wings were split into two batches. The first batch had a weight of about 2010 grams, which was coated with sauce and then added to the fryer. The second batch had a weight of about 940 grams, and was batter breaded and then added to the fryer.

For the first batch, the method includes frying the spent fowl wings in a deep fryer for about one minute and 30 seconds at about 190 degrees Celsius or 375 degrees Fahrenheit. It was noted that the spent fowl wings were slightly golden in color and had a good bite, the moisture was retained, and the spent fowl wings tasted juicy. It was noted that the end weight was about 1542 grams, the yield from frying was about 76%, and the weight (after the sauce was added) was about 1930 grams (a pick-up of 20%), and the yield was determined to be about 96%.

For the second batch, the method includes dusting the spent fowl wings, running the spent fowl wings through an egg mixture, and breading the spent fowl wings with a cornmeal and flour breading.

For the first batch, the method includes frying the spent fowl wings in a deep fryer for about 1 minute and 30 seconds at about 190 degrees Celsius or 375 degrees Fahrenheit. It was noted that the color of the spent fowl wings was golden yellow, and the spent fowl wings stated juicy and tender. It was noted that the end weight was about 1100 grams, and the pick-up from batter breading was 17%.

### Sixth Example

For the sixth example, plain water was used with no seasoning and no marinade.

The method includes obtaining an amount of the raw spent fowl wings (for example, 1516 grams). The start weight was about 1516 grams.

The method includes placing plain water in the pressure cooker 300, and bringing the water to a boil. The method also included adding spent flow wings into the pressure cooker 300 and operatively covering the pressure cooker 300. The method also included increasing the internal pressure of the pressure cooker 300 to about 15 pounds per square inch, and then cooking the spent fowl wings for about 18 minutes. The method also included operatively releasing the internal pressure of the pressure cooker 300 in such a way that the internal chamber of the pressure cooker becomes depressurized and the heat is dissipated from the pressure cooker 300. It was noted that the cooked spent fowl wings were tender (soft to the bite), and the mature skin, mature meat and the mature tendons were soft. However, the spent fowl wings appeared to be stiff although edible. It was noted that the post pressure cooked weight of the cooked spent fowl wings was about 974 grams and the yield was about 64.25%.

The method further included placing the cooked spent fowl wings in the fryer 400 for between about three minutes to about four minutes at about 190 degrees Celsius or 375 degrees Fahrenheit. It was noted that the wings were slightly golden in color, and had a good bite; the cooked mature fowl wings were relatively tougher but edible. Once the spent fowl wings sat at room temperature for approximately one hour, the cooked spent fowl wings were somewhat tougher to the bite and the look of the wing is still stiff after removal from the fryer 400. It was concluded that the ingredients appeared to contribute to the breakdown of the mature skin, and to the softening of the mature meat and the mature tendons.

### Seventh Example

For the seventh example, plain water was used with seasoning but with no marinade. In addition, overcooking was used in this example.

The method includes obtaining an amount of the raw spent fowl wings (for example, 1482 grams). The start weight was about 1482 grams.

The method includes placing the seasoning and water in the pressure cooker 300, and bringing the water to a boil. The method further included adding the spent fowl wings to the pressure cooker 300 and covering the pressure cooker 300. The method further included cooking the spent fowl wings for about 45 minutes once the internal pressure of the pressure cooker had an internal pressure that reached about 15 pounds per square inch. The method further included releasing the internal pressure of the pressure cooker 300, and allowing the heat to dissipate from the pressure cooker 300. It was noted that the spent fowl wings were relatively tender, and the mature skin, mature meat and mature tendons were soft. Much of the mature skin was ripped but the spent fowl wings appeared to be held together.

The method further included covering the pressure cooker 300, and bringing the water back to a boil; once under pressure of about 15 pounds per square inch, the spent fowl wings were further cooked (under pressure) for about an additional 15 minutes. It was noted that the spent fowl wings were very soft and fell apart to the touch; the mature skin was torn from over cooking, and falling off the wing. The post pressure cooked weight was about 900 grams; the yield was about 60.73%.

The method further included placing the cooked spent fowl wings in the fryer 400, and cooking the wings for about three minutes at about 190 degrees Celsius or about 375 degrees Fahrenheit. It was noted that the spent fowl wings were slightly golden in color; the mature meat was tender but dry to the bite. It appeared that about 60 minutes of cooking in the pressure cooker 300 under about 15 pounds per square inch is an outer limit (for the given raw spent fowl wings that were used in this case).

### Eighth Example

For the eighth example, no soy was used (in two batches).

For the first batch of the eighth example, no soy was used with plain frying.

The method includes obtaining an amount of the raw spent fowl wings (for example, 6944 grams). The weight of the raw spent fowl wings was about 6944 grams, the weight of the marinade was about 306 grams, the weight of the water was about 735 grams; the total weight placed in the standing bowl was about 7985 grams. The method further included allowing the spent fowl wing wings and marinade to stand in combination for about 70 minutes. It was noted that the total wing weight post marinade was about 7410 grams and the yield pickup was about 6.3%.

The method further included: (A) placing water into the pressure cooker 300, and bringing the water to a boil; (B) adding the spent fowl wings into the pressure cooker 300, and covering the pressure cooker 300; (C) cooking the contents of the pressure cooker 300 for about 18 minutes once the internal pressure of the pressure cooker 300 reached an internal pressure of 15 pounds per square inch; and (D) releasing the pressure of the internal chamber of the pressure cooker 300 and allowing the heat to dissipate. It was noted that the spent fowl wings were tender; the mature skin, the mature meat and the mature tendons were soft. It was noted that the post pressure cooked weight was about 4842 grams, and the yield was about 65.34%.

The method further included placing the spent fowl wings (that were pressure cooked) into the fryer 400 for between about one minute to about two minutes at 190 degrees Celsius or 375 degrees Fahrenheit. It was noted that the spent fowl wings were slightly golden in color, and the mature meat was tender, and the bite was good. A slight flavor difference was noted and a slightly tougher appearance.

For the second batch of the eighth example, no soy was used and a gluten-free batter-breaded marinade was used.

The method includes obtaining an amount of the raw spent fowl wings (for example, about 5034 grams), a marinade (about 222 grams), water (about 533 grams) for a total weight into a standing bowl of about 5789 grams. The spent fowl wings were soaked in the marinade for about 120 minutes. The total wing weight post marinade was about 5272 grams, and the yield pickup was about 4.5%; it is noted that a longer marinade time without tumbling reduces the yield.

The method further included: (A) placing the ingredients and water in the pressure cooker 300, and bringing the water to a boil; (B) adding the spent fowl wings and covering the pressure cooker 300; (C) cooking the spent fowl wings for about 18 minutes once the internal pressure of the pressure cooker reached about 15 pounds per square inch; and (D) removing the cooked spent fowl wings from the pressure cooker 300, and allowing the heat to dissipate (it was noted that it took about eight minutes to reach about zero pounds per square inch (for the pressure cooker 300). It was noted that the post pressure cooked weight was about 3278 grams, and the yield was about 65.11%.

The method further included running the cooked spent fowl wings through an egg mixture and then applying a simple corn flour and seasoning breading to the cooked spent fowl wings.

The method further included frying the breaded cooked spent fowl wings in the fryer 400 for about one to about two minutes at about 190 degrees Celsius or 375 degrees Fahrenheit. It was noted that the wing color was golden yellow, and the spent fowl wings were juicy and tender; the mature skin, mature meat and mature tendons were soft, and the coating was crispy. It was noted that the end weight was about 3108 grams, and the yield was about 61.74%. It was noted that the spent fowl wings cooked without soy results in a relatively lower yield and changes flavor.

FIGS. 6C and 6D depict examples of an apparatus 900 for cooking mature animal portions.

In general terms, the apparatus 900 is for cooking mature animal portions. The apparatus 900 includes (and is not limited to) a combination of a pressure-cooking section 902 and a fryer-cooking section 904. The pressure-cooking section 902 is configured to (A) receive the mature animal portions, and (B) cook the mature animal portions that were received under pressure with boiling water. The fryer-cooking section 904 is positioned relative to the pressure-cooking section 902. The fryer-cooking section 904 is configured to (A) receive the mature animal portions that were pressure cooked, and (B) fry the mature animal portions that were pressure cooked with boiling oil.

In accordance with a specific option of the apparatus 900, the apparatus 900 further includes a marinating section 906 positioned relative to the pressure-cooking section 902. The marinating section 906 is configured to (A) receive the mature animal portions, and (B) marinate the mature animal portions prior to pressure cooking the mature animal portions. In addition, the pressure-cooking section 902 is further configured to receive the mature animal portions from the marinating section 906.

In accordance with another specific option of the apparatus 900, the apparatus 900 further includes a frame assembly 908 configured to support the pressure-cooking section 902 and the fryer-cooking section 904. In accordance with another specific option of the apparatus 900, the apparatus 900 further includes a frame assembly 908 configured to support the pressure-cooking section 902, the fryer-cooking section 904 and the marinating section 906.

An example of the pressure-cooking section 902 is depicted in FIGS. 3A to 3C. An example of the fryer-cooking section 904 is depicted in FIG. 4. An example of the marinating section 906 is depicted in FIG. 2.

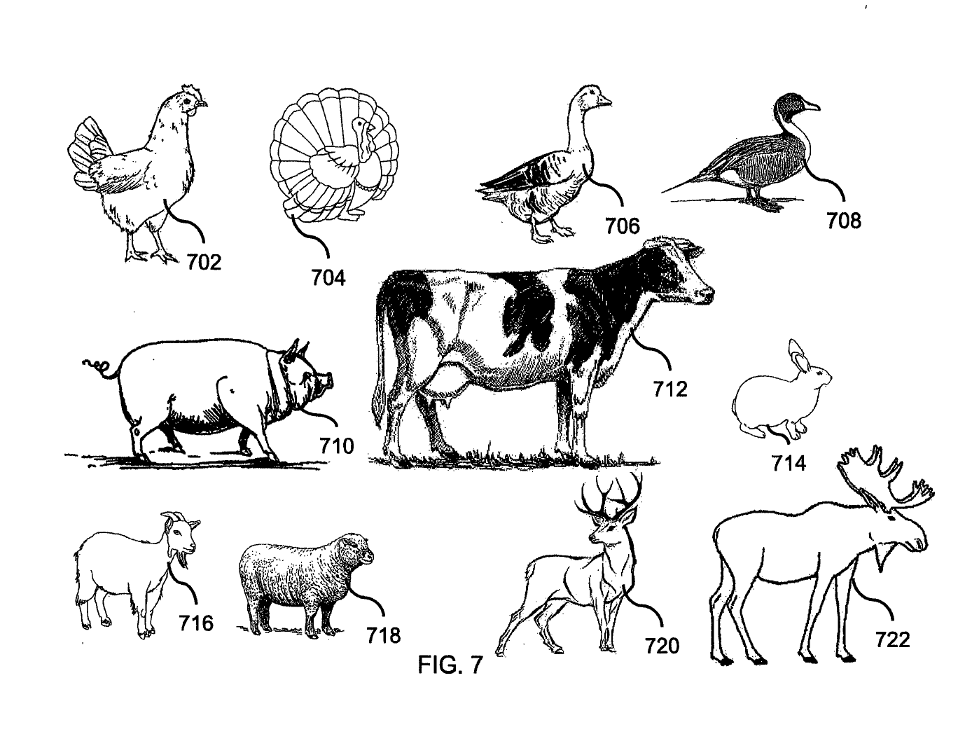

FIG. 7 depicts examples of mature animals that may provide mature animal portions to be used in the cooking method 600 of FIGS. 6A and 6B for cooking the mature animal portions.

The mature animals that may be rendered to provide the mature animal portions for the cooking method 600 includes (and is not limited to): a chicken 702, a turkey 704, a goose 706, a duck 708, a pig 710, a cow 712 (beef cattle or a domesticated mature animal), a rabbit 714, a goat 716, a sheep 718 (lamb), a deer 720, and/or a moose 722 (wild mature animal).

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. It may be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, or components, that are superior to any of the equivalents available to the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for the purposes of this document, that the phrase “includes” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

What is claimed is:

1. A cooking method for cooking mature animal portions, the cooking method comprising:
a pressure-cooking operation including cooking the mature animal portions under pressure; and
a fry-cooking operation including frying the mature animal portions that were pressure cooked, and the mature animal portions being cooked by the pressure-cooking operation and the fry-cooking operation are palatable for user consumption.

2. The cooking method of claim 1, further comprising:
a marinating operation including marinating the mature animal portions prior to pressure cooking the mature animal portions.

3. The cooking method of claim 1, wherein:
the pressure-cooking operation includes cooking the mature animal portions under pressure in a pressure-cooking section with boiling water.

4. The cooking method of claim 1, wherein:
the fry-cooking operation includes frying the mature animal portions that were pressure cooked in a fryer-cooking section with boiling oil.

5. The cooking method of claim 1, wherein:
the pressure-cooking operation includes cooking the mature animal portions at a predetermined pressure range for a predetermined amount of time.

6. The cooking method of claim 1, wherein:
the fry-cooking operation includes frying the mature animal portions that were pressure cooked at a predetermined temperature range for a predetermined amount of time.

7. The cooking method of claim 1, wherein:
the pressure-cooking operation includes cooking the mature animal portions under pressure at about 15 pounds per square inch for between about 18 minutes and about 20 minutes.

8. The cooking method of claim 1, wherein:
the fry-cooking operation includes frying the mature animal portions that were pressure cooked in boiling oil between at about degrees Fahrenheit and at about degrees Fahrenheit for about 60 seconds to about 70 seconds.

9. The cooking method of claim 1, wherein:
the mature animal portions include:
mature chicken portions.

10. The cooking method of claim 1, wherein:
the mature animal portions include:
mature chicken wings.

11. A cooking method for cooking raw mature chicken wings, the cooking method comprising:
including obtaining the raw mature chicken wings;
including bringing water in a pressure cooker to a boil;
including adding the mature chicken wings to the boiling water in the pressure cooker;
including bringing the water to boil again in the pressure cooker with wings in the water;
including cooking the mature wings under pressure for a predetermined time;
removing the pressure-cooked mature chicken wings from the pressure cooker, and allowing water to drain from the chicken wings;
adding the pressure-cooked wings to boiling cooking oil in a fryer; and
deep frying the pressure-cooked wings in boiling oil at a predetermined temperature range for a predetermined period of time.

12. The cooking method of claim 11, further comprising:
air drying the deep fried wings, and allowing excess oil to drip from the deep fried wings.

13. The cooking method of claim 12, further comprising:
freezing the cooked wings for packaging for commercial sale.

14. The cooking method of claim 11, further comprising:
an operation (B) including marinating the mature chicken wings that were obtained in a marinating apparatus prior to pressure cooking the mature chicken wings.

15. A cooking method for cooking spent fowl wings, the cooking method comprising:
cooking the spent fowl wings in a pressure cooker for a predetermined time at a predetermined pressure;
cooking the spent fowl wings that were cooked in the pressure cooker in a fryer for a predetermined time without a predetermined temperature for frying.

16. A cooking method for cooking raw mature animal portions, the cooking method comprising:
a pressure-cooking operation including placing the raw mature animal portions in a pressure cooker, and cooking the raw mature animal portions received in the pressure cooker for a predetermined time at a predetermined pressure of the pressure cooker; and
a fry-cooking operation, including placing mature animal portions that were cooked in the pressure-cooking operation in a fryer, and cooking the spent fowl wings received in the fryer for a predetermined time without a predetermined temperature for frying the mature animal portions.

17. An apparatus for cooking mature animal portions, the apparatus comprising:
a pressure-cooking section being configured to: (A) receive the mature animal portions, and (B) cook the mature animal portions that were received under pressure with boiling water; and
a fryer-cooking section being positioned relative to the pressure-cooking section, and the fryer-cooking section being configured to: (A) receive the mature animal portions that were pressure cooked, and (B) fry the mature animal portions that were pressure cooked with boiling oil.

18. The apparatus of claim 17, further comprising:
a marinating section being positioned relative to the pressure-cooking section, and the marinating section being configured to: (A) receive the mature animal portions, and (B) marinate the mature animal portions prior to pressure cooking the mature animal portions; and
wherein the pressure-cooking section is further configured to receive the mature animal portions from the marinating section.

19. The apparatus of claim 18, further comprising:
a frame assembly configured to support the pressure-cooking section and the fryer-cooking section.

20. The apparatus of claim 18, further comprising:
a frame assembly configured to support the pressure-cooking section, the fryer-cooking section and the marinating section.
